(19) United States
(12) Patent Application Publication
(10) Pub. No.: US 2013/0001162 A1
(43) Pub. Date: Jan. 3, 2013

(54) Apparatus, System, and Method for Forward Osmosis in Water Reuse

(76) Inventors: Victor Yangali-Quintanilla, Bjerringbro (DK); Zhenyu Li, Thuwal (SA); Rodrigo Valladares Linares, Thuwal (SA); Gary Amy, Thuwal (SA)

(21) Appl. No.: 13/535,819

(22) Filed: Jun. 28, 2012

Related U.S. Application Data
(60) Provisional application No. 61/501,881, filed on Jun. 28, 2011.

(51) Int. Cl. B01D 63/00; B01D 65/02; B01D 61/08; C02F 1/44

(52) U.S. Cl. 210/636; 210/489; 210/321.72; 210/256; 210/257.2; 210/85; 210/90; 210/295; 210/137; 210/644; 210/648

(57) ABSTRACT

An apparatus, system, and method for desalinating water is presented. The invention relates to recovery of water from impaired water sources by using FO and seawater as draw solution (DS). The seawater becomes diluted over time and can be easily desalinated at very low pressures. Thus, a device consumes less energy when recovering water. The apparatus, system and method comprise an immersed forward osmosis cell.

### CROSS-REFERENCE TO RELATED APPLICATIONS

This application claims priority to U.S. Provisional Application No. 61/501,881 filed Jun. 28, 2011, the entire contents of which is specifically incorporated herein by reference without disclaimer.

### BACKGROUND OF THE INVENTION

1. Field of the Invention

This invention relates to forward osmosis used in water reuse and more particularly relates to an apparatus system and method for forward osmosis in desalinating and purifying waste water.

2. Description of the Related Art

With the increasing economic and population growth, the demand for water is also increasing. Under an average economic growth scenario and if no efficiency gains are assumed, global water demand will increase 53% by 2030, from 4.5 trillion m³ to 6.9 trillion m³. The water demand increment represents a 40% increase over current accessible, reliable supply water, but the deficit may be more than 50% for one-third of the population living in basins within developing countries. This situation argues for the need to preserve and reuse water in water stressed countries, and therefore domestic wastewater reuse is gaining popularity. The water-industry standard for water reclamation is mainly comprised of high-energy consuming processes, in which secondary wastewater effluents are treated with microfiltration/ultrafiltration, reverse osmosis (RO) and even advanced oxidation processes like UV radiation combined with hydrogen peroxide addition. Forward osmosis (FO) compared to the aforementioned technologies can contribute to increased water reuse at lower energy consumption, and therefore, a considerable cost reduction is feasible.

The growth of the desalination market in countries with or approaching, physical water scarcity is a fact confirmed by a recent state of the art desalination report. Most of the countries with water scarcity or approaching it are located in the Middle East and North Africa (MENA) region. In the global scenario, from 2000 to 2005 the installed desalination capacity grew at a compound average rate of 12%, and the compound annual growth rate of installed capacity from 1997 to 2007 was 7.9%. In the period 2010-2020 the global cumulative contracted capacity of the desalination market will grow at a cumulative average growth rate of 10.5%, reaching 195.8 million m³/day in 2020. The real price of desalinating water by seawater reverse osmosis (SWRO) is nowadays in the range $0.5-1/m³, which is a reduced cost with energy recovery devices, but the cost will not continue decreasing because equipment and energy costs will increase. The current and forecasted situation means that the price of water will probably increase when subsidies are gradually withdrawn in the Middle East. Water reuse will play an important role to lessen water treatment costs. Global Water Intelligence predicts a 181% increase of the global water reuse capacity over the years 2005-2010 and, in comparison, the growth of the desalination capacity over the same period was predicted as 102%. There is a close link between desalination and water reuse, and FO membranes can act as bridge between the two processes. Studies indicated that the hybrid process of FO and RO is economically favorable for recoveries of water up to 63%.

Organic micropollutants are of concern in water reuse. Organic micropollutants (also known as emerging organic contaminants) are compounds such as pharmaceutically active compounds, endocrine disrupting compounds, organic compounds derived from personal care products and other organic compounds discharged by diverse industries. Micropollutants are either only moderately or not removed during wastewater treatment. The problem of micropollutants is inherent to water reuse; hence an acceptable technology for water reuse should be able to remove emerging organic contaminants. FO membranes may act as double barrier in combination with RO to reject most of the emerging contaminants, or a single barrier when used for partial desalination.

Presented here are practical uses of FO membranes that demonstrate a FO membrane configuration can achieve indirect desalination of seawater at reduced costs. In an embodiment of the invention, a plate and frame FO membrane is used with real seawater as a draw solution and secondary wastewater effluent as a feed water to achieve partial desalination at low pressure. A low pressure reverse osmosis (LPRO) step may be added in order to achieve full desalinization at a lower energy cost.

The referenced shortcomings are not intended to be exhaustive, but rather are among many that tend to impair the effectiveness of previously known techniques in water filtration; however, those mentioned here are sufficient to demonstrate that the methodologies appearing in the art have not been satisfactory and that a significant need exists for the techniques described and claimed in this disclosure.

### SUMMARY OF THE INVENTION

From the foregoing discussion, it should be apparent that a need exists for an apparatus, system, and method for desalinating water sources.

A first general embodiment of the invention is an immersion forward osmosis cell apparatus comprising: a first and second frame shaped plate; an inner frame; and a first and second forward osmosis membrane, where the cell is assembled in the order of the first plate, the first membrane, the frame, the second membrane and the second plate, such that each membrane is located between a plate and the frame. This embodiment may further comprise two o-rings located between each membrane and the frame and/or two o-rings located between each membrane and each plate. The immersion forward osmosis cell may additionally comprise one or more ingress tubes and one or more egress tubes, where the ingress tubes and egress tubes are attached to the cell on the opposite sides of each other. The cell may be configured to be water tight, such that liquid only enters or exits the cell through the membranes and/or through the ingress or egress tubes.

Another general embodiment of the invention is an apparatus comprising: a draw solution tank; a immersion forward osmosis cell; a pump; egress tubing; and ingress tubing, where the immersion forward osmosis cell is connected to the to the draw solution tank through the ingress tubing and through the egress tubing; and where the pump is connected to either the ingress or the egress tubing. The apparatus may further comprise a feed water tank and the cell may be located in the feed water tank. The feed water tank and/or draw solution tank may also comprises an air scouring system a stirrer, a temperature monitor, a temperature control feature, a conductivity probe and/or be connected to additional tubing that is configured to supply feed water. The feed water tank may also have a balance located under it. The ingress and/or ingress tubing may be connected to a pressure gauge. The pump may be a low pressure pump and/or a gear pump that operates at less than 20 bars, less than 15 bars, or less than 10 bars, for example. The draw solution may be connected to additional tubing that is configured to supply fresh draw solution to the draw solution tank or to withdraw processed draw solution from the tank. The apparatus may further comprise a computer and the computer may be configured to monitor and/or control the apparatus. Any and all monitoring equipment such as the balance, temperature and/or conductivity monitors may be connected to the computer. Any and all of the control specific mechanisms, such as the pumps, may be connected to and controlled by the computer. The apparatus may further comprise a low pressure reverse osmosis module. The low pressure reverse osmosis module may run at reduced pressures such as less than 20 bar, less than 15 bar, less than 10 bar, or less than 5 bar, for example. The low pressure reverse osmosis system may comprise a positive displacement pump, a reverse osmosis cross-flow filtration cell, stainless steel tubing, needle valves, a pressure gauge, a stirrer, a conductivity probe a balance, a temperature monitor, a temperature control mechanism, and/or a proportional pressure relief valve. The low pressure reverse osmosis system may be connected to the draw solution tank or may comprise an additional pre-reverse osmosis tank. The pre-reverse osmosis tank may be connected to the draw solution tank through tubing. The low pressure reverse osmosis system may also comprise a post-reverse osmosis tank. The immersion forward osmosis cell may be configured as described in the first general embodiment.

Another general embodiment of the invention is a method for desalinating water, the method comprising: providing an immersion forward osmosis cell connected to a source of draw solution; immersing the forward osmosis cell in feed water; pumping the draw solution through the forward osmosis cell and back into the draw solution source. The draw solution may be salt water and the feed water may be waste water. After processing by forward osmosis, the salt water will become partially desalinated. In an embodiment of the invention, the pumping comprises the use of a gear pump. In specific embodiments of the invention, attributes of the system are monitored, such as the conductivity, the temperature, the weight, the volume, the fouling of membranes and the like. System attributes may be monitored through conductivity probes, temperature probes, balances, and the like. The results of the monitored attributes may be sent to a computer. The computer may monitor the volume, the weight, and/or the conductivity of the draw solution tank. Once the computer detects that the conductivity, the weight, or the volume of the draw solution and/or the feed water is below a predetermined level, the draw solution and/or the feed water may be replaced with new draw solution and/or feed water, starting a new cycle. The feed water and/or the draw solution may be stirred. The forward osmosis cell may be air scoured when the membranes within the cell are fouled or soiled. The method may further comprise measuring the pressure of the pumped draw solution. After processing the draw solution may be filtered using low pressure reverse osmosis. The low pressure reverse osmosis system may desalinate the forward osmosis processed feed water. The low pressure reverse osmosis may comprise a positive displacement pump, a reverse osmosis cross-flow filtration cell, stainless steel tubing, needle valves, a pressure gauge, a stirrer, a conductivity probe a balance, a temperature monitor, a temperature control mechanism, and/or a proportional pressure relief valve. The immersion forward osmosis cell may be configured as described in the first general embodiment.

The terms “coupled,” “connected,” or “attached” as used herein include physical attachment, whether direct or indirect, permanently affixed or adjustably mounted connections. Thus, unless specified, these terms are intended to embrace any operationally functional connection.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is an schematic of an embodiment of a FO and LPRO setup.

FIG. 2 is an illustration of cycles of forward osmosis process showing the volume of FW, DS, fDS (fresh draw solution).

FIG. 3 is a schematic of the immersion FO cell.

FIG. 4 is a schematic of center section (frame) of the immersion FO cell.

FIG. 5 is a schematic of the outer sections (plates) of the immersion FO cell.

FIG. 6 is a schematic of a forward osmosis (FO) experimental setup.

FIG. 7 is a graph a) FO flux and b) conductivity decline of DS; thin-film layer facing feed water, and support layer facing seawater.

FIG. 8 a) is a graph of the rejection percent vs. molecular weight vs. log D of twelve contaminates through the FO and LPRO membranes and b) is a graph of rejection percent vs. equivalent width vs. log D of twelve contaminates through the FO and LPRO membranes.

FIG. 9 is a SEM photograph of a cross section and top view of a FO membrane showing a non-homogenous thin-film layer.

FIG. 10 is a SEM photograph of a clean membrane top.

FIG. 11 is a proposed mechanism of rejection for Bisphenol A (BPA) and 17α-ethynilestradiol (EE2).

FIG. 12 is a scheme for definition of reversible and irreversible fouling: NF (normalized flux).

FIG. 13 is a graph of the forward osmosis flux versus time, and modeled FO flux versus time.

FIG. 14 is a graph of normalized forward osmosis flux versus time, SWWE (secondary wastewater effluent).

FIG. 15 is a graph of concentration of total dissolved solids (TDS) in draw solution (DS) and permeate of LPRO versus time.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules, in order to more particularly emphasize their implementation independence. A module is “[a] self-contained hardware or software component that interacts with a larger system. Alan Freedman, “The Computer Glossary” 268 (8th ed. 1998). A module comprises a machine or machines executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

In the following description, numerous specific details are provided, such as examples of system setup and components. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

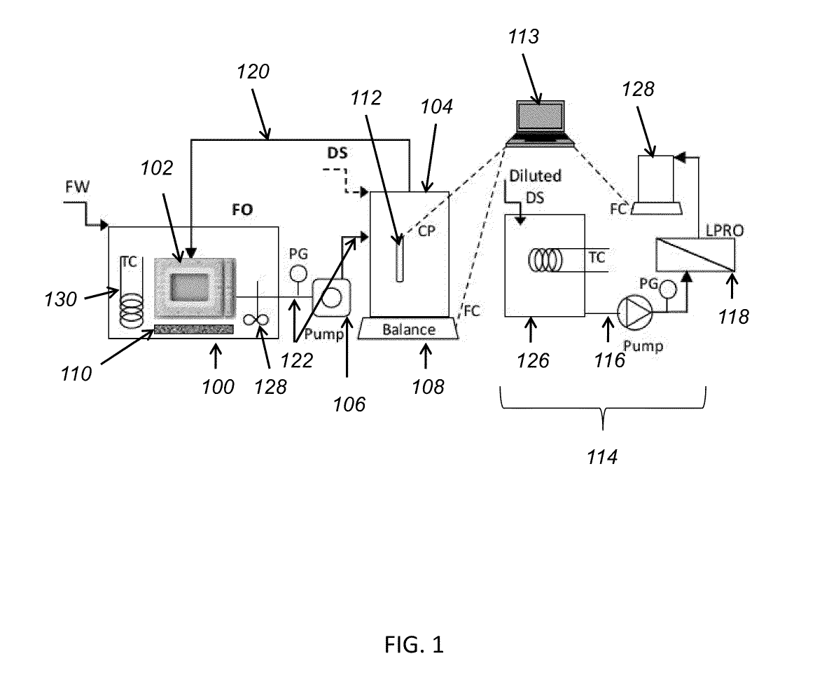

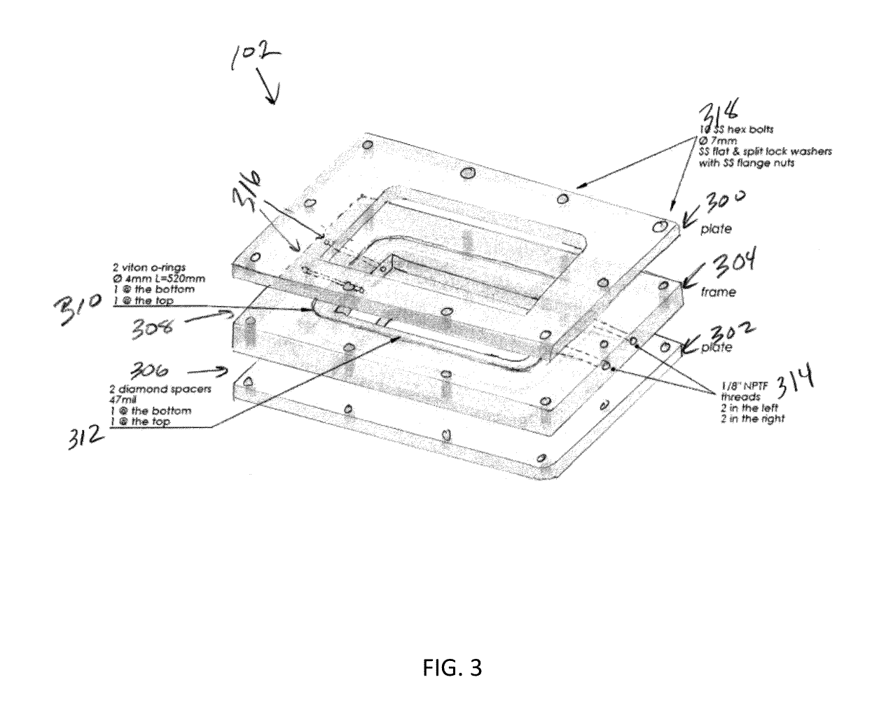

The invention relates to recovery of water from impaired water sources by using FO and seawater as draw solution (DS). The seawater becomes diluted over time and can be easily desalinated at very low pressures. Thus, the device consumes less energy when recovering water. A layout of an embodiment of the forward osmosis (FO) device is shown in FIG. 1. Specific embodiments of the FO cell are illustrated in FIGS. 3-5. The FO cell 102 may be a plate and frame assembly, the assembly is described in the components subsection. The FO cell 102 accommodates two flat-sheet FO membranes implemented in parallel. The membrane cells are immersed in a tank 100 containing feed water (FW), and are connected to a receptacle 104 containing the draw solution (DS). A gear pump 106 is used to continuously recirculate the DS inside the cell 102 formed by the membrane and frame. A balance 108 may be used as a mass flow controller when connected to a computer. An air scouring system 110 may be used in the bottom of the FW tank to hydraulically clean the FO membrane after long-term use. The conductivity of the draw solution may be monitored with an online conductivity meter 112 connected to a computer 113. The computer may also be connected to the balance 108 and to gates or valves that control the flow of DS, FS, and others. The low pressure reverse osmosis setup (LPRO) 114 may be implemented alongside the FO implementation and be comprised of a positive displacement pump 116, a cross-flow filtration cell 118 accommodating RO membrane such as a 139 cm² membrane, needle valves, pressure gauges, a proportional pressure relief valve and/or stainless steel tubing. Any FO membrane may be used, such as those made by Hydration Technology Innovations, LLC. (HTI, Albany, Oreg.). Any RO membrane may be used, such as an aromatic polyamide RO membrane, BW-30 (Dow-Filmtec, Midland, Mich.). Membranes used may be selected depending on the contaminated water source, such that the membrane used filters out the main contaminates. Stirring assemblies 128 may be added to any of the tanks to circulate the water within. Chiller and heater assemblies 130 may control temperature variations. Ingress tubing 120 connects the draw solution tank 104 to the cell 102. The ingress tubing 120 may be attached to the draw solution tank 104 or may be immersed in the fluid located in the draw solution tank 104. In either of these embodiments, the ingress tubing 120 is referred to as being “connected” to the draw solution tank 104. As long as fluid is able to flow from the draw solution tank 104 into the ingress tubing 120, the tubing 120 is considered to be “connected” to the draw solution tank 104. The ingress tubing is connected to the cell 102 in such a way that the fluid from the ingress tubing 120 enters the cell between the two forward osmosis membranes. Egress tubing 122 connects the cell 102 to the draw solution tank 104. The egress tubing 122 is connected to the cell in such as way that the fluid inside of the cell 102 enters the egress tubing 122. The egress tubing 122 is further connected to the draw solution tank 103. The egress tubing 122 is considered to be “connected” to the draw solution tank 104 as long as the fluid that exits the egress tubing 122 enters the draw solution tank 104. A pump 106 may be connected to either the egress or the ingress tubing. A pressure gauge 124 is connected to either the ingress tubing 120 or the egress tubing 122. The pressure gauge 124 may also be monitored by the computer 113.

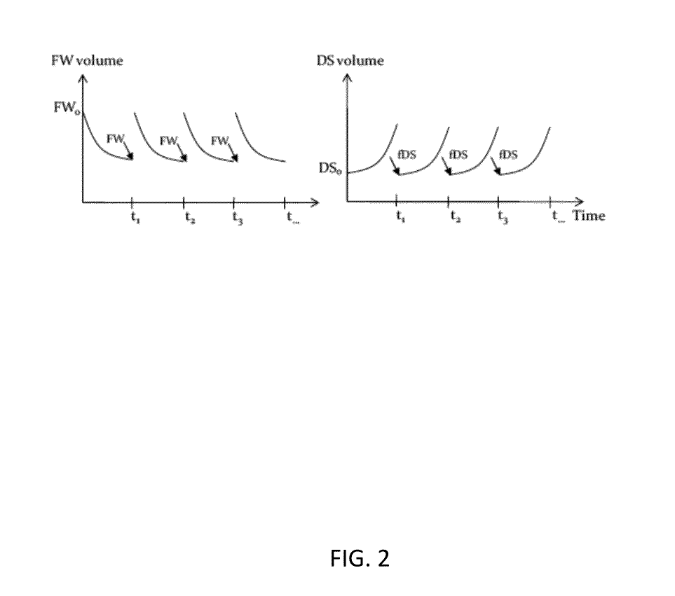

The device starts operating after placing impaired water in the FO tank 102 (primary waste water being treated, secondary wastewater effluent). Then, seawater is poured into the DS tank 104. The seawater may be pre-filtered. The recirculation pump 106 operates at a flow rate of 100 mL/min, for example, and dilution of the DS begins. Meanwhile the conductivity and flow rate data acquisition is also started and may be monitored at the computer 113. The low flow rate in the FO cell 102 channel allows a hydraulic transversal flow of the feed water to inside the cell 102 channel driven by osmotic difference. The flow allows a reduced energy consumption of the system, when compared to counter flow FO membrane contactors. A stirrer 128 may be used to provide horizontal movement of the feed water inside the tank, with water flowing across the membrane. An example of the global velocity gradient is 50 s−1. A FO cycle may last any length of time, but specific lengths are 4 hours, 8 hours, 12 hours or 24 hours. The length of time will depend on the size of the tanks, the FO membrane used, and the initial amounts of feed water and draw water. A FO cycle may also not be timed, and instead ends when the weight of the DW tank exceeds a specific amount, when the volume of the DW tank exceeds a specific amount, when the volume or weight of the FW tank is below a certain point, and/or when the conductivity of the FW is below a certain point, for example. In one embodiment, the draw solution can increase its volume up to 3.5 times depending on the initial TDS difference between the FW (2.5 g/L as TDS) and the DS (seawater 40.5 g/L as TDS). After a FO cycle is concluded, the FW either goes into a pre-LPRO holding tank 126, or goes directly through a LPRO 118 cycle. A post-LPRO tank 128 may also be used. Once the FW tank is emptied after a completed FO cycle it is refilled with FW and a new FO cycle begins. In one example, after 24 h of dilution, the diluted DS is transferred to the feed tank of the LPRO setup for final treatment at less or equal to 15 bar. The recovery some examples of the FO device is about 7% per cycle, but can be incremented (up to 20%) by reducing the feed tank volume or by immersing more FO cells (up to 3) in the FW tank. The cycle is repeated replacing the fresh DS, filling FW to the FO tank, and then filling the diluted DS to the LPRO tank 118. The operational cycling is represented in FIG. 2.

In an embodiment of the invention, a forward osmosis sequential batch reactor (FO-SBR) converts the FW tank into a reactor that functions as a sequential batch reactor (SBR). In this way, the cycles of an SBR are combined with the FO cycles to deliver diluted DS that can be later treated or directly used in agriculture and aquaculture.

### Components

An embodiment of the forward osmosis cell 102 is illustrated in FIG. 3. The forward osmosis (FO) cell 102 may be made of PMMA (Poly methyl methacrylate), commercially known as Plexiglas or similar. The device is used as a plate and frame membrane holder immersed in water. The unit has two plates 300 and 302 on both sides of the frame 304. Two FO flat-sheet membranes 306 and 308 are inserted into the area designated 306 and 308 in FIG. 3 and are used in both sides of the cell. Two o-viton rings 310 may be placed in grooves of the frame 304. The o-viton rings 310 make the structure water-tight (from inside to outside and vice versa) when the cell 102 is immersed in water. The frame 304 also supports the use of plastic spacers 312 (rhombus shape, for example) to increase the turbulence of the flow in the cell 102. The device is assembled by placing two FO membranes 306 and 308 in both sides of the frame, and then placing the plates to join with bolts and nuts the whole structure. Thus a water tight membrane cell 102 is formed, which allows the flow of water inside the membrane cell, but prevents any passage of water from the outside, except water flowing through the membranes 306 and 308. Input 314 and output access holes 316 allow for the connection of tubing to cell to allow for the flow of water through the cell. In an embodiment of the invention one hole provides input flow and one hole provides output flow, however, two holes may also provide for input and output flow. In an embodiment of the invention, the input and output holes are located on opposite sides of the cell, allowing for unimpeded flow of water through the cell. The frame 304 and plates 300 and 302 have additional holes, such as threaded holes that allow for the placement of bolts, nuts and washers through the frame 302 and the plates 300 and 302 to allow for the water tight connection of the cell 102 assembly. In another embodiment, the plate and frames do not have additional holes and the plates, frames and membranes are assembled through a clamping type means on two or more of the cell sides. The clamping type means could be a spring clamp or C-clamp, for example.

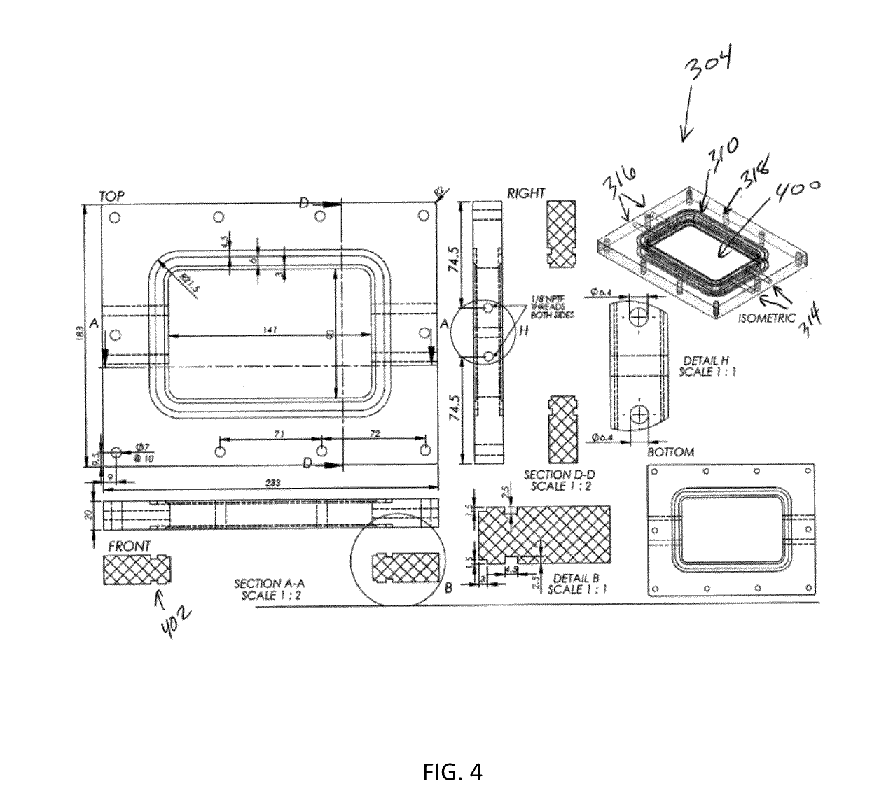

FIG. 4 is a schematic of the inner frame 304. The frame 304 contains a cutout region that forms the inside of the cell 102 in which the water will circulate. The frame may also include a indentation 402 that runs along the inner cut out in which a o-ring may be placed. Input 341 and output 316 access holes allow for access of the water into and out of the cell 102. These access holes may be threaded to allow for a water tight connection to tubing that runs to and from the cell 102. Holes 318 run through the frame to allow for connection to the matching plates. The input and output holes may be connected to ingress and egress tubes through tube fittings, for example.

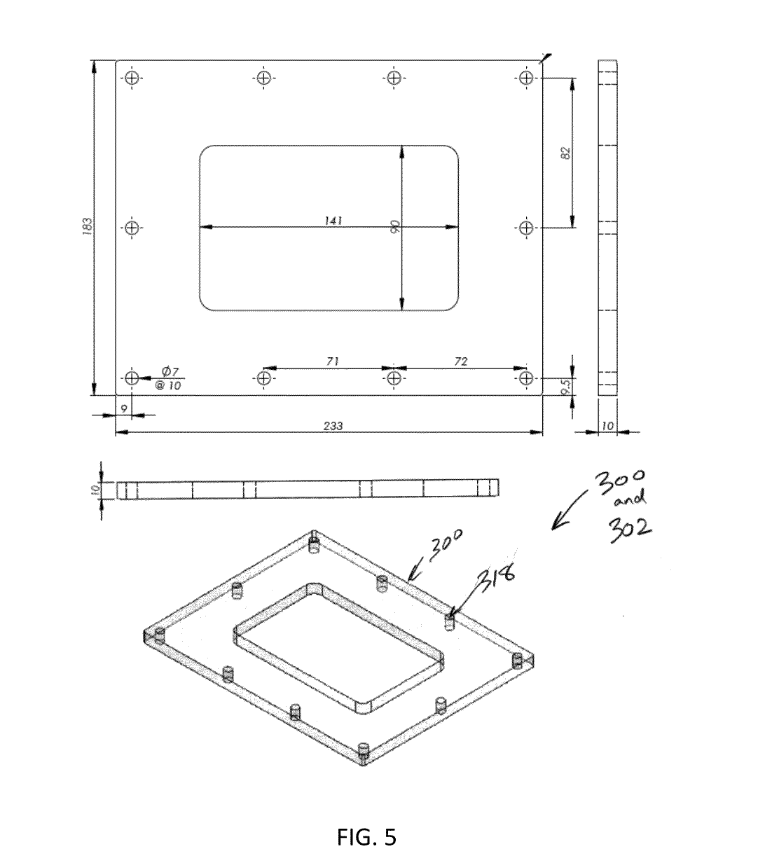

FIG. 5 is a schematic of an outside plate 300 for the osmosis cell 102. The plate contains holes 318 throughout to allow for the connection of the plate to the membranes and the frame.

Plastic tubing and piping, and non-corrosive components may be used in the invention to prevent corrosion from salt water.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

The main objective of this example is to study the potential of FO membranes to reject a cocktail of 12 organic micropollutants spiked into a secondary wastewater effluent used as a feed water (FW) in a submerged configuration of a plate and frame FO membrane, and using real seawater as a draw solution.

Forward osmosis (FO) is an emerging technology that can be applied in water reuse applications. Osmosis is a natural process that involves less energy consumption than reverse osmosis (RO), and therefore is expected to compete favorably with current water reuse technologies. Nonetheless, the study of its capabilities as an effective barrier against organic micropollutants (pharmaceuticals, endocrine disrupters and personal care products) remains to be demonstrated. The present research describes the application of FO membranes for water reuse by using secondary wastewater effluent as a feed solution and Red Sea water as draw solution. Moreover, this example evaluates the removal of organic micropollutants (OMPs) to determine if FO membranes can be a good barrier in rejecting such contaminants. For FO, rejections of hydrophobic neutral compounds varied between 8% and 80%; rejections of hydrophilic neutral compounds varied in the range of 29% and 75%; and negative ionic compounds were rejected between 94-95%. However, the coupling of FO with low pressure reverse osmosis (LPRO) resulted in increased (combined) rejections of more than 98%. The mechanisms of rejection were dependent on the physicochemical properties of the solute and the membrane characteristics.

### Materials and Methods

### FO and RO Membranes, and Testing Unit

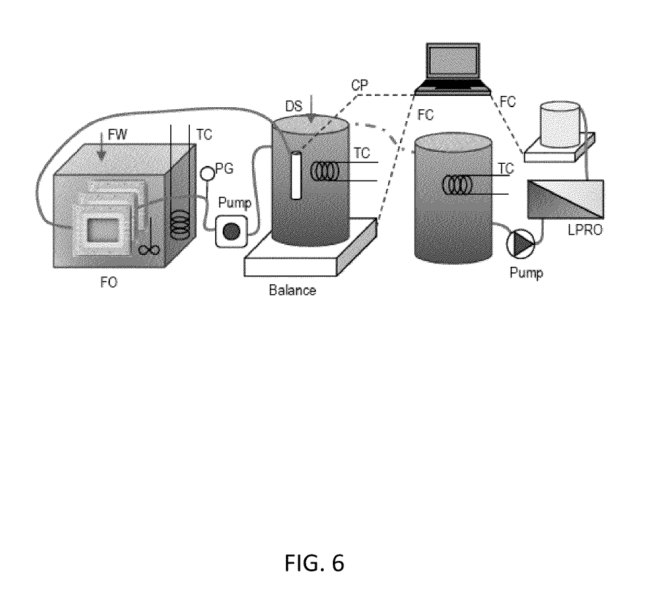

The FO membrane was provided by Hydration Technology Innovations, LLC (HTI, Albany, Oreg.). The HTI membrane (with a support mesh) was shipped as flat sheet coupons (4″×6″). A layout of the experimental setup is shown in FIG. 6. The membrane cell was a custom-made plate and frame assembly as described previously, the assembly is shown in FIGS. 3-5. The cell accommodates flat-sheet membranes with a total area of 404 cm² in a plate and frame configuration, two membrane cells in parallel were implemented. The membrane cells were immersed in a tank containing feed water, and were connected to a receptacle containing the draw solution (DS). A gear pump (Coleparmer) was used to continuously recirculate the DS inside the cell formed by the membrane and frame. This new FO configuration is different from the FO membrane contactors described in previous publications. A balance (TE6101, Sartorius AG, Gottingen, Germany) was used as a flow (and flux) controller when connected to a computer. The conductivity of the draw solution was also monitored with a conductivity meter (WTW, Weilheim, Germany) connected to a computer. The temperature of the water solutions was kept constant 20±0.5° C. by using chiller/heater devices. The low pressure reverse osmosis setup (LPRO) was comprised of a positive displacement pump (Hydra-Cell, Minn.), a cross-flow filtration cell accommodating a 139 cm² membrane (SEPA CF II, Sterlitech, Kent, Wash.), needle valves, pressure gauges, a proportional pressure relief valve and stainless steel tubing (Swagelok BV, Netherlands). An aromatic polyamide, brackish water RO membrane, BW-30 (Dow-Filmtec, Midland, Mich.), was used for LPRO. The operating pressure of the LPRO was 15 bar, providing a flux of 7 L/m²-h and a recovery of 2%. The recovery of the FO system was 7.3% per cycle, but with some modifications is able to be operated at a recovery of 20%. FO recovery is defined as the quotient of the volume of water extracted from the feed water and the initial volume of feed water.

The contact angles of clean and fouled FO membranes were measured with a goniometer CAM200 (KSV, Finland) by using the sessile drop method. The fouled membrane samples were dried for 24 hours at room temperature (20° C.). Photographs of FO membranes were obtained by using a scanning electron microscope (SEM), model Magellan™ XHR SEM 400 (FEI, the Netherlands).

### Feed Waters and Procedures

Seawater (40.5 g/L as TDS, pre-filtered with 0.45 μm pore size filters, conductivity 57500 μS/cm) was used as the draw solution. The pH of the seawater was 7.8, and the temperature was adjusted to 20±0.5° C. The dissolved organic carbon (DOC) was measured as 1 mg/L. The seawater was collected from the line that provides seawater to the existing reverse osmosis desalination plant at KAUST, located near the town of Thuwal, Saudi Arabia, along the Red Sea coast. The FO tank contained a secondary wastewater effluent (SWWE, feed water, FW), which was collected from the Al Ruwais wastewater treatment plant in Jeddah, Saudi Arabia, where the wastewater (after primary treatment) is treated in activated sludge aeration tanks Pre-treatment of the SWWE was not performed. The BOD₅ of the wastewater effluent was 20 mg/L, and the DOC was 5 mg/L. The pH of the feed water was 7.3, the conductivity was 3300 μS/cm, and the temperature was maintained constant at 20±0.5° C. The experimental procedure started by pouring feed water (FW) in the FO tank. Then, 1 L of pre-filtered seawater was poured into the DS tank. The recirculation pump was started at a flow rate of 100 mL/min and dilution of the DS started, meanwhile the conductivity and flow rate data acquisition were also started. The low flow rate in the channel allowed a hydraulic transversal flow of the feed water to inside the channel only driven by osmotic difference. The low flow certainly impacts the energy consumption of the system, which was minimal indeed, if compared to counter-flow membrane contactors. A stirrer was used to provide horizontal movement of the feed water inside the tank, with water flowing across the membrane; the global velocity gradient was 50 s⁻¹. The dilution experiment was performed for 24 hours; the draw solution increased its volume due to continuous osmosis between the feed water and the draw solution recirculating in the cells. After 24 h of dilution, the diluted DS was transferred to the feed tank of the LPRO setup. The cycle was repeated every day by replacing the DS with fresh DS, and then filling the LPRO feeding tank. The orientation of the FO membrane faced the active layer to the feed water (FW-AL) and the support layer faced the draw solution.

### Micropollutants and Analyses

The organic compounds were purchased from Sigma Aldrich (Munich, Germany). The list of micropollutants is presented in Table 1. Compounds were classified into neutral and ionic according to their ion speciation in water; physicochemical properties were also calculated. Information about software used for calculation of compound properties is presented in Table 1.

TABLE 1

| | | | | Molec. | Molec. | Molec. | Equiv. | |
|---|---|---|---|---|---|---|---|---|
| | Name | MW | log D^{a} | length | Width | Depth | width | |
| Name | ID | (g/mol) | (pH 7) | (nm)^{b} | (nm)^{b,c} | (nm)^{b} | (nm)^{b} | Group^{a} |
| 1,4-dioxane | DIX | 88 | −0.17 | 0.71 | 0.66 | 0.52 | 0.59 | HL-neu |
| Acetaminophen | ACT | 151 | 0.23 | 1.14 | 0.68 | 0.41 | 0.53 | HL-neu |
| Metronidazole | MTR | 171 | −0.27 | 0.93 | 0.9 | 0.48 | 0.66 | HL-neu |
| Phenazone | PHZ | 188 | 0.54 | 1.17 | 0.78 | 0.56 | 0.66 | HL-neu |
| Caffeine | CFN | 194 | −0.45 | 0.98 | 0.87 | 0.56 | 0.70 | HL-neu |
| Carbamazepine | CBM | 236 | 2.58 | 1.20 | 0.92 | 0.58 | 0.73 | HL-neu |
| Bisphenol A | BPA | 228 | 3.86 | 1.25 | 0.83 | 0.75 | 0.79 | HB-neu |
| 17α-ethynilestradiol | EE2 | 296 | 3.98 | 1.48 | 0.87 | 0.84 | 0.85 | HB-neu |
| Naproxen | NPX | 230 | 0.34 | 1.37 | 0.78 | 0.75 | 0.76 | Ionic |
| Fenoprofen | FNP | 242 | 0.38 | 1.16 | 0.93 | 0.74 | 0.83 | Ionic |
| Gemfibrozil | GFB | 250 | 2.3 | 1.58 | 0.94 | 0.65 | 0.78 | Ionic |
| Ketoprofen | KTP | 254 | −0.13 | 1.16 | 0.92 | 0.74 | 0.83 | Ionic |

^{a}ADME/Tox Web Software, hydrophobic (HB) when log D > 2.6, hydrophilic (HL)
when log D < 2.6, ionic compounds shown in the table are negatively charged at pH 7, neutral
compounds are abbreviated neu; log D is the ratio of the equilibrium concentrations of all species
(unionized and ionized) of a molecule in octanol to the same species in the water phase.
^{b}Molecular Modeling Pro.
^{c}equivalent width = (width × depth)\hat{ }0.5.

The cocktail of compounds was spiked from a stock solution with a concentration of approximately 1 mg/L each. The targeted individual concentration of the individual micropollutant in the SWWE was approximately 10 μg/L. Water samples of the spiked SWWE and the “as-collected” SWWE were analyzed for micropollutants content. A water sample of the diluted draw solution was collected as a composite sample on the 3^{rd} and 4^{th} day of experimental cycles. This approach allowed steady-state saturation of the membranes during 2 days; which means that an adequate estimation of rejection was performed, avoiding overestimation. Finally, a blank sample (pure water in container used for shipment) and a sample of the permeate of the LPRO were also collected. Micropollutants in water samples were analyzed by Technologiezentrum Wasser, (TZW, Karlsruhe, Germany). The uncertainty of measurement was ±20% for each compound; the supporting information Table 2 elaborates more on this and also indicates limits of quantification and limits of detection (Table 3).

TABLE 2

| | | | | | Blank | |
|---|---|---|---|---|---|---|
| | sample | WWE | WWE | DS | sample, | Permeate |
| | unit | collected | spiked | diluted | DI water | LPRO |
| 1,4-Dioxane | μg/L | <0.5 | 9.2 | 4.3 | <0.5 | <0.5 |
| 17α-Ethinylestradiol | | <0.005 | 7.3 | 1.5 | <0.001 | <0.001 |
| Bisphenol A | | <0.025 | 7.6 | 7.0 | <0.005 | 0.058 |
| Carbamazepine | μg/L | 0.27 | 9.9 | 2.5 | <0.01 | 0.02 |
| Caffeine | μg/L | (0.08) | 13 | 3.2 | <0.01 | 0.03 |
| Fenoprofen | μg/L | 0.30 | 11 | 0.67 | <0.01 | <0.01 |
| Gemfibrozil | μg/L | 0.70 | 12 | 0.62 | <0.01 | <0.01 |
| Ketoprofen | μg/L | 0.11 | 7.9 | 0.39 | <0.01 | <0.01 |
| Metronidazole | μg/L | 0.05 | 7.5 | 4.1 | <0.01 | 0.08 |
| Naproxen | μg/L | 0.06 | 9.9 | 0.62 | <0.01 | <0.01 |
| Acetaminophen | μg/L | 0.07 | 8.3 | 5.9 | <0.01 | 0.31 |
| Phenazone | μg/L | (0.03) | 7.6 | 2.3 | <0.01 | 0.01 |

TABLE 3

| | | | | | Blank | |
|---|---|---|---|---|---|---|
| | sample | WWE | WWE | DS | sample, | Permeate |
| | unit | collected | spiked | diluted | DI water | LPRO |
| 1,4-Dioxane | μg/L | 0.5 | 0.5 | 0.5 | 0.5 | 0.5 |
| 17α-Ethinylestradiol | | 0.005 | 0.005 | 0.001 | 0.001 | 0.001 |
| Bisphenol A | | 0.025 | 0.025 | 0.005 | 0.005 | 0.005 |
| Carbamazepine | μg/L | 0.05 | 0.05 | 0.01 | 0.01 | 0.01 |
| Caffeine | μg/L | 0.1 | 0.1 | 0.01 | 0.01 | 0.01 |
| Fenoprofen | μg/L | 0.05 | 0.05 | 0.01 | 0.01 | 0.01 |
| Gemfibrozil | μg/L | 0.05 | 0.05 | 0.01 | 0.01 | 0.01 |
| Ketoprofen | μg/L | 0.05 | 0.05 | 0.01 | 0.01 | 0.01 |
| Metronidazole | μg/L | 0.05 | 0.05 | 0.01 | 0.01 | 0.01 |
| Naproxen | μg/L | 0.05 | 0.05 | 0.01 | 0.01 | 0.01 |
| Acetaminophen | μg/L | 0.05 | 0.05 | 0.01 | 0.01 | 0.01 |
| Phenazone | μg/L | 0.05 | 0.05 | 0.01 | 0.01 | 0.01 |

### Results and Discussion

### Variations of Flux and Conductivity

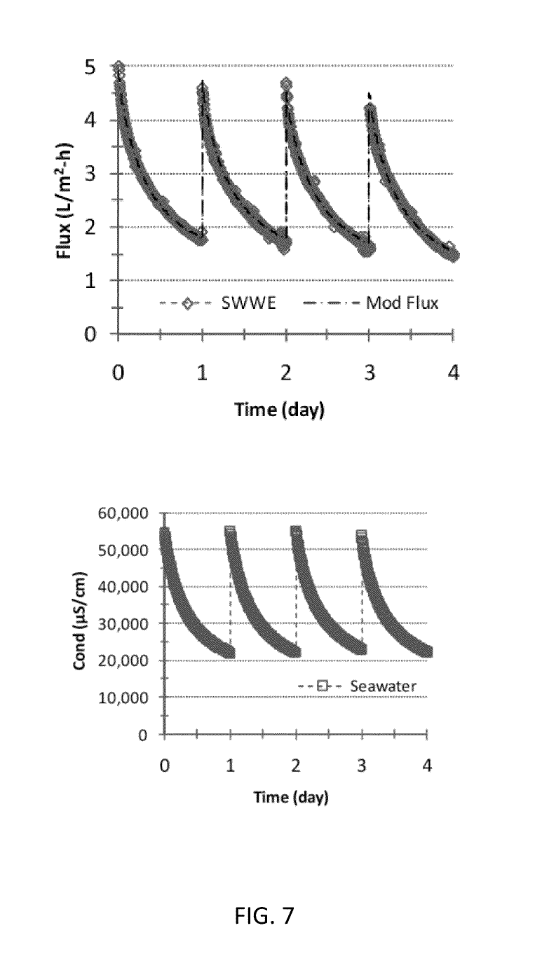

As mentioned in the experimental procedure section, 1 L of seawater was continuously diluted by the feed water flowing into the osmotic membrane cell. Over time, the flux decreased due to the decrease of the driving osmotic pressure difference, which is demonstrated by the conductivity decreasing (FIG. 7). An equation was derived for the flux of osmosis membranes when a low concentrated solution is facing the thin-film side of the membrane, and the porous support (mesh) is facing a high concentrated solution. After some slight modifications, Loeb's equation (Eq. 1) can be applied to model the flux decline of the dilution experiment.

$${J}_{w} = \frac{1}{K} ln ( \frac{{π}_{Hi}}{{π}_{Low}} ) \qquad ( 1 )$$

Where J_{w} is the osmotic water flux, K is the solute resistivity of the membrane, π_{Hi} is the osmotic pressure in the high concentrated solution, and π_{Low} is the osmotic pressure in the low concentrated solution. The conductivity can be assumed to be directly proportional to the concentration of the draw solution and hence also proportional to the osmotic pressure, and the same can be said for the feed water. In this case π_{sw}=π_{Hi} and π_{FW}=π_{Low}. By using the assumption that for the seawater being diluted by the feed water, ln(π_{SW}/π_{FW})≈α(γ_{SW}−γ_{FW})+β with γ denoting conductivity, Eq. 1 can be written as Eq. 2; in this way K′ can be calculated by fitting the data of conductivity measurements of the feed water and the draw solution. The modeled flux (mod flux), shown in FIG. 7, is obtained by using the estimated K′ in Eq. 2, and the conductivity data over time. The results demonstrate that only osmosis took place between the thin-film layer of the FO membrane facing the feed water and the draw solution recirculating inside the cells; no negative pressure, inside the cells, was observed during the time of recirculation of draw solution.

$${J}_{w} = \frac{1}{{K}^{′}} ( {γ}_{SW} - {γ}_{FW} ) \qquad ( 2 )$$

Another cause of flux decline was fouling of the FO membrane in the top layer side, which was also occurring over time as shown in FIG. 7. Fouling was accounted for in the model by calculating solute resistivity of the membrane for each cycle. Fluxes of the FO process varied between 1.5 to 5 L/m²−h. The dilution of the DS during 1 day with a fresh volume of DS was intentionally carried out, in order to obtain a brackish feed with a minimum osmotic pressure for the LPRO setup. The operating pressure of the LPRO was only 15 bar. The use of seawater is an appropriate draw solution for water reuse applications with FO membranes. Seawater is preferred over concentrate (retentate) from existing desalination plants because: i) shorter-term versus long-term periods of osmotic operation in order to obtain a convenient dilution of the draw solution; ii) lower operating costs for desalination of the diluted solution against high-energy desalination similar to high pressure RO. However, if the final objective is concentration of a feed water (either wastewater or SWWE); then, brines can be used as DS to increase fluxes.

### Rejection of Micropollutants by FO

The results of concentrations of micropollutants in water samples corresponding to collected SWWE, initial spiked SWWE, diluted DS, blank sample of deionized (DI) water, and permeate of LPRO are presented in Table 2. Rejections achieved by the FO and RO membrane were calculated with equation 3.

$$Rejection ( \% ) = ( 1 - \frac{C}{{C}_{0}} ) \times 100 \qquad ( 3 )$$

For rejection by FO, Cₒ is the concentration of the feed water (spiked SWWE), and C is the concentration of the diluted DS. For rejection by RO, Cₒ is the concentration of the diluted draw solution, and C is the concentration of the permeate.

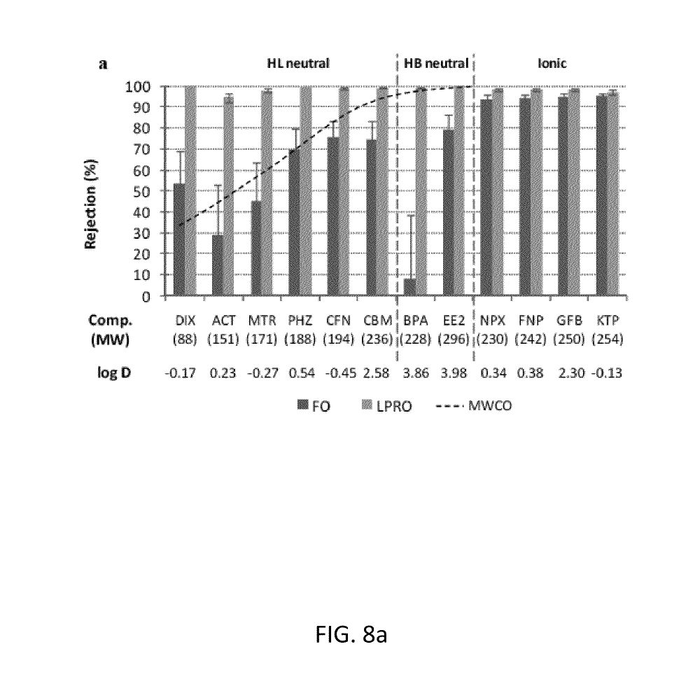

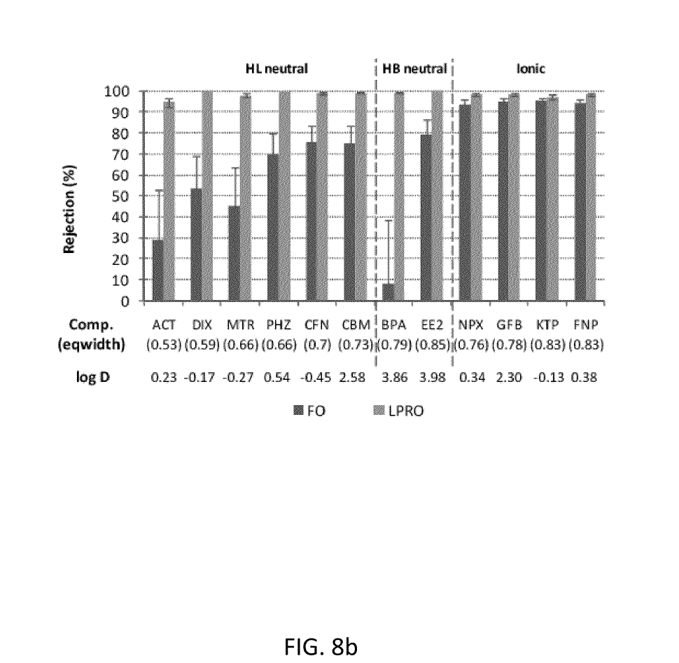

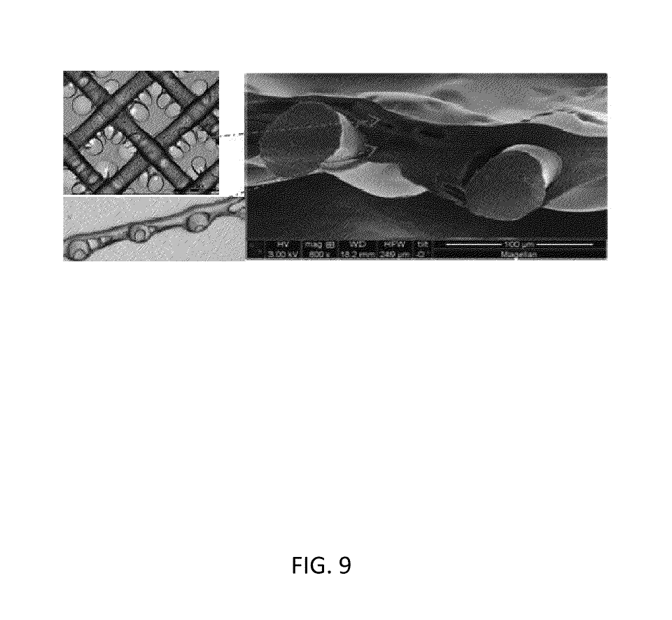

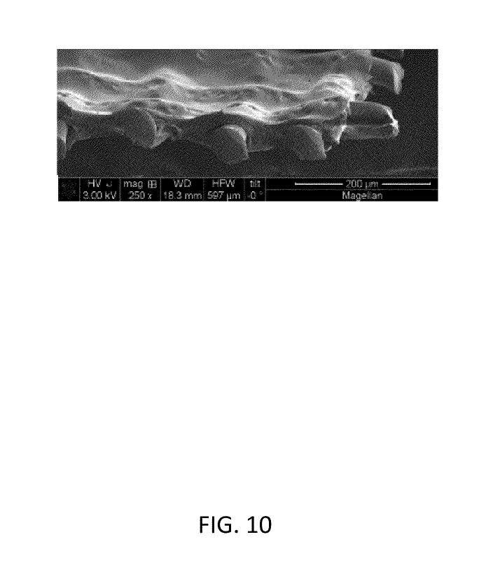

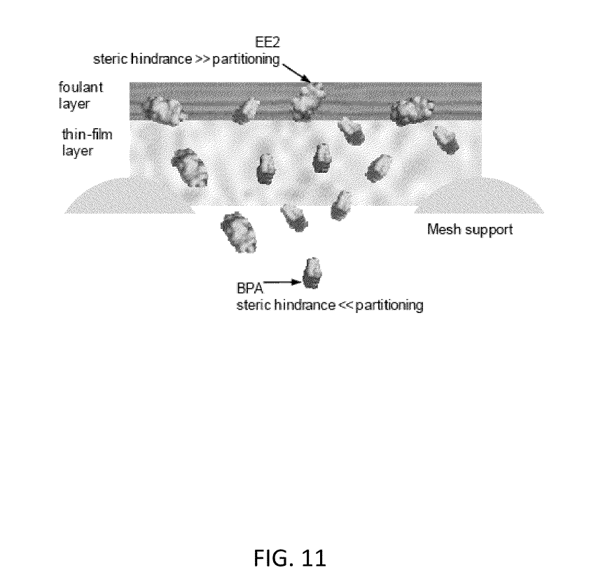

Rejections by FO membranes were compared to rejection by LPRO (diluted DS used as feed); the results are presented in FIG. 8. Hydrophilic neutral compounds (DIX, ACT, MTR, PHZ, CFN, CBM) show rejections that can be related to the molecular weight (MW) of the compound as depicted in FIG. 8 a. Considering the neutrality and low hydrophobicity of compounds such as PHZ and CFN, or those with lower MW, the MWCO (defined according to 90% rejection) of the FO membrane can be “roughly” assumed to be around 200 Da. Scanning electron microscopy (SEM) photographs revealed that the thickness of the thin-film top layer of an FO membrane is not homogenous (FIG. 9), which helps to explain the variations of rejections between hydrophilic neutral compounds. Carbamazepine (CBM) is neutral, but it lies in the boundary between hydrophobicity and hydrophilicity (log D=2.58); thus, if a compound with a similar MW, but hydrophilic, were tested, then its rejection would be greater than 75%. Rejection of DIX was greater than rejection of ACT; although DIX has a lower MW than ACT, the equivalent width of ACT is lower, thus rejections for ACT were lower (FIG. 8b). It has been demonstrated that rejections of organic compounds by NF and RO membranes are related to the size of the compound rather than strictly the MW, and rejection is also related to the hydrophobicity of the organic compound. The latter consideration may explain the rejections achieved for hydrophobic neutral compounds: Bisphenol A (BPA) and 17α-ethynilestradiol (EE2). Rejection of Bisphenol A (8-39%) was the lowest achieved by the FO membrane; this occurred due to the hydrophobicity of the compound and less hydrophilicity of the membrane compared to a NF membrane; the measured contact angle of the clean FO membrane (made of cellulose triacetate) was 60°±2.7, and that of a fouled membrane was 49°±3. The contact angles of clean polyamide NF membranes (Filmtec-Dow, NF-200 and NF-90) were reported as 37.5° and 58°, respectively, the difference being explained due to distinct effective pore sizes, i.e., NF-200 absorbing more water during measurement with the sessile drop method, thus appearing more hydrophilic. The contact angle may be an inexact parameter for quantifying hydrophobicity or hydrophilicity of a “fouled” membrane, and the compaction and composition of a dried foulant layer may erroneously produce results that do not reflect the true hydrophobicity of the composite foulant layer and the membrane itself. In FIG. 8, it is shown that rejection of EE2 was favored by the size of the compound (size exclusion or steric hindrance). Although EE2 is a hydrophobic neutral compound (log D 3.98), its rejection was favored by its size when trying to partition through the FO membrane (FIGS. 10 and 11, steric hindrance >>partitioning). In contrast, the smaller size of BPA combined with its hydrophobicity and less hydrophilicity of the FO membrane, was detrimental in its rejection; the compound adsorbed, and after saturating the membrane, the compound partitioned/diffused across the thin-film layer (FIGS. 10 and 11). Cartinella et al. (23) reported rejections greater than 99.5% for estrone (MW 270, log D 3.46) and estradiol (MW 272, log D 3.94) by an FO membrane under experimental conditions different from those carried out in this study. Finally, the rejection results of negatively charged ionic compounds (NPX, FNP, GFB, KTP) by the FO membrane can be explained by steric hindrance effects and electrostatic repulsion between the negative charge of the membrane surface and the negative charge of the compound at pH 7.3.

### Rejection of Micropollutants by LPRO

The RO membrane (BW-30) was able to reject micropollutants with rejections of more than 97% (except for ACT, 95%). The MWCO of BW-30 can be assumed to be around 100 Da, which may explain the almost complete rejection provided by the membrane. The feed water used for the LPRO was the diluted seawater containing some of the micropollutants (0.4-7 μg/L, Table SI).

### New FO Membranes

The scope of this example can be implemented further by using new generations of FO membranes. For instance, the new-generation high performance thin-film composite FO membrane, or the trend of development of FO hollow fibers may provide or may not provide acceptable removals of micropollutants. However, an improvement in flux may impact the passage of contaminants, with their later occurrence in LPRO membranes located downstream.

Perspectives for Use of Concentrated FW from FO

The concentrated feed water (either SWWE or wastewater) obtained from the FO system can be used as feed of another system, for instance, for production of energy. An anaerobic reactor is an option, but a second option is the use of microbial fuel cells. It has been investigated that wastewaters with high conductivity can reduce electrolyte ohmic losses (voltage loss) of a bioelectrochemical system.

In real conditions of water reuse applications, FO membranes were able to reject most of the organic micropollutants; rejections were mainly moderate (29-75%) and high (95%), with one exception, BPA (8-39%). LPRO after FO was quite effective, rejecting micropollutants at more than 98%. The use of energy during experiments was minimal during the FO process; similarly, the recovery of water was also performed at lower energy (LPRO) when compared to high pressure RO. Thus, the FO-RO hybrid offers significant energy advantages. Forward osmosis membranes can be an effective barrier against most organic micropollutants, reaching high levels of rejection when coupled with low pressure (low-energy) reverse osmosis.

### Example 2

### Materials, Methods and Experimental

Hydration Technology Innovations, LLC (HTI, Albany, Oreg.) provided flat-sheet membranes (HydroWell, with a support mesh). A schematic of the experimental setup is shown in FIG. 6. A plate and frame FO membrane cell was used for experiments. The cell supports two flat-sheet membranes with a total area of 202 cm², and, with the active layer (thin-film) facing the feed water, and, with the support layer facing the draw solution. Two cells were immersed in a tank containing feed water, and were connected to a tank containing the draw solution (DS). A pump (Coleparmer, USA) recirculated the DS inside the cell. The conductivity of the draw solution was also monitored with a conductivity meter (WTW, Weilheim, Germany) connected to a computer. A balance (TE6101, Sartorius AG, Göttingen, Germany) was used as flow (and flux) controller when connected to a computer. The temperature of the water solutions was controlled at 20±0.5 C.° by using chiller/heater devices. The RO membrane used was a BW-30 (Dow-Filmtec, Midland, Mich.). The low pressure reverse osmosis setup (LPRO) was comprised of a positive displacement pump (Hydra-Cell, Minn.), a cross-flow filtration cell accommodating a 139 cm² flat-sheet membrane (SEPA CF II, Sterlitech, Kent, Wash.), needle valves, pressure gauges, a proportional pressure relief valve and stainless steel tubing (Swagelok BV, Netherlands). The LPRO was operated at a net driving pressure of 15 bar, at a flux of 7 L/m²−h, with a recovery of 2%, this limitation of flux and recovery was due to the use of only one SEPA cell. The draw solution was real Red Sea seawater (pre-filtered with 0.45 μm filters, 40.5 g/L as TDS). The dissolved organic carbon (DOC) was approximately 1 mg/L. The seawater was collected from the line that provides seawater to the existing reverse osmosis desalination plant at KAUST, located near the town of Thuwal along the Red Sea coast. A secondary wastewater effluent (SWWE) without pre-treatment was collected from the Al Ruwais wastewater treatment plant in Jeddah, Saudi Arabia. The BOD₅ of the wastewater effluent was 20 mg/L, and the DOC was 5 mg/L. The pH of the feed water was 7.3, the TDS was 2430 mg/L, and the temperature was adjusted to 20±0.5 ° C. The experiments were conducted in sequential cycles, as shown in FIG. 2. The FIG. shows that the experiments started with an initial volume (30 L) of SWWE (named feed water, FW) in the FO tank, with a small volume (1 L) of pre-filtered seawater (named draw solution, DS) in the DS tank. Subsequently, only one pump was used for recirculation of the DS at a flow rate of 100 mL/min. The low flow rate in the channel allowed a hydraulic flow of the feed water to inside the channel only driven by osmotic difference. The low flow rate of recirculation allowed a reduced energy consumption of the system, when compared to counter-flow FO membrane system. A stirrer operating at 320 RPM was used to provide movement of the feed water inside the tank, with water flowing across the membrane. After 24 hours, the DS increased its volume due to continuous osmosis between the feed water and the draw solution recirculating in the cells. The FW decreased its volume every day, but more FW was poured to the FW tank after each cycle. The diluted DS was transferred to the feed tank of the LPRO setup. The cycle was repeated every day by replacing the fresh DS, and then filling the LPRO feeding tank.

### Theoretical Background

The osmotic flux of the FO membranes was calculated using Equation 4. Where ΔV is the differential volume change of draw solution (L); A is the membrane area (m²); and t is the time (h).

J=ΔV/At (4)

The osmotic flux is proportional to the driving osmotic pressure difference, which is demonstrated by the decrease in conductivity. An equation (Equation 5) for the flux of osmosis membranes when a low concentrated solution is facing the thin-film side of the membrane, and the porous support (mesh) is facing a high concentrated solution was derived by Loeb et al. [19].

$${J}_{w} = \frac{1}{K} ln ( \frac{{π}_{Hi}}{{π}_{Low}} ) \qquad ( 5 )$$

Where J_{w} is the osmotic water flux, K is the solute resistivity of the membrane, π_{Hi} is the osmotic pressure in the high concentrated solution, and π_{Low} is the osmotic pressure in the low concentrated solution. Loeb's equation can be slightly modified and applied to model the flux decline of the dilution experiment. The conductivity can be assumed to be directly proportional to the concentration of the draw solution and hence also proportional to the osmotic pressure, the same can be said for the feed water. In this case π_{SW}=π_{Hi} and π_{FW}=π_{Low}. Assuming that for the seawater and the feed water, ln(π_{SW}/π_{FW})≈α(γ_{SW}−γ_{FW})+β, with γ denoting conductivity, Equation 5 can be written as Equation 6; in this way K′ can be calculated by fitting the data of conductivity measurements of the feed water and the draw solution. The modeled flux is obtained by using the estimated K′ in Equation 6, and the conductivity data over time.

$${J}_{w} = \frac{1}{{K}^{′}} ( {γ}_{SW} - {γ}_{FW} ) \qquad ( 6 )$$

It was reported the occurrence of dilutive internal concentration polarization (dilutive ICP) of the FO membrane when the DS is against the support layer, which is the membrane orientation used during the experiments. Also reported was the occurrence of dilutive ICP in the reverse mode (the active layer against the feed solution, the support layer against the draw solution). It was concluded that changes in the cross-flow velocities did not affect the water flux across the membrane. Dilutive ICP is not detrimental to the membrane and water flux because seawater contains small solutes (such as sodium chloride) that quickly are diluted by the FW and diffuse back to the interior of the circulating DS.

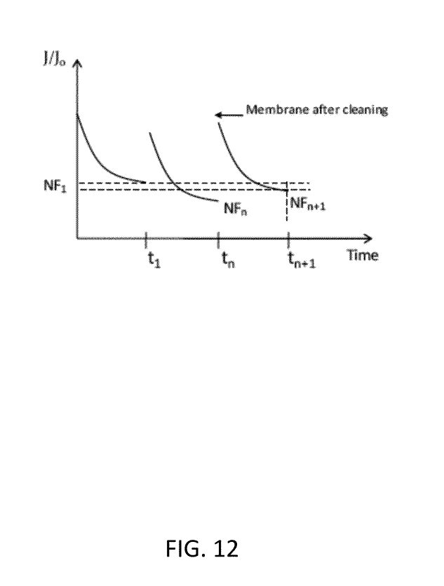

The components of natural organic matter (NOM) present in a SWWE are the most important foulants in water reuse facilities operating with membranes. During FO, interactions between the membrane and the NOM in the feed water cause membrane fouling and therefore a decrease of the membrane flux, besides a decrease of flux due to dilution of the DS. For filtration systems operating in batch cycles, reversible, and irreversible fouling can be represented by differences of normalized fluxes (FIG. 12). Reversible fouling means that this fouling can be removed with membrane cleaning such as air scouring or chemical cleaning of the membrane. Reversible fouling involves a relatively medium-term build-up of a foulant layer or the formation of a cake layer at the surface (active layer) of the FO membrane. Irreversible fouling is that when washing or chemical cleaning does not restore the original flux value, it is caused by more or less permanent deposition of particles on the surface of the membrane, and is characterized by a longer-term decline in flux. After a certain number of cycles (n) and at the end of a filtration period of n cycles, the flux decline is defined as:

$$FD ( \% ) = \frac{( {NF}_{1} - {NF}_{n} )}{{NF}_{1}} \times 100 \qquad ( 7 )$$

Where FD is defined as flux decline, NFₙ is the final normalized flux after n filtration cycles, and NF₁ is the final normalized flux after the first cycle. The apparent irreversible fouling is defined as:

Ira(%)=(NF₁31 NFₙ₊₁)×100 (8)

Where Ira is defined as apparent irreversible fouling, NFₙ₊₁ is the final normalized flux after cleaning the membrane after n cycles of operation (air scouring with FW, air scouring with clean water, chemical cleaning) and NF₁ is the final normalized flux after the first cycle. The reversible fouling (Rv) is defined as:

Rv(%)=(1−Ira)x100 (9)

### Results and Discussion

### Feed Water and Draw Solution Characterization

The characteristics of the S WWE (effluent from Jeddah) are summarized in Table 4. The pre-filtered seawater (Red Sea water) follows the characterization given in Table 5.

TABLE 4
Wastewater effluent characteristics

| | SWWE Jeddah |
|---|---|
| Temperature (° C.) | 20.7 |
| Conductivity (μS/cm) | 4300 |
| pH | 7.3 |
| DOC (mg/L) | 5.3 |
| BOD₅ (mg/L) | 20 |
| UVA₂₅₄ (1/cm) | 0.130 |
| SUVA (L/mg m) | 2.45 |
| Calcium (mg/L) | 108 |
| DO (mg/L) | 6.3 |

TABLE 5
Seawater (SW) characterization

| | 0.45 μm pre-filtered SW |
|---|---|
| Conductivity (μS/cm) | 57500 |
| Temperature (° C.) | 20.5 |
| pH | 7.8 |
| DOC (mg/L) | 1.12 |
| UVA₂₅₄ (1/cm) | 0.012 |
| SUVA (L/mg m) | 1.07 |
| TDS (mg/L) | 40500 |
| SDI | 2 |
| Barium (mg/L) | 0.01 |
| Calcium (mg/L) | 571 |
| Magnesium (mg/L) | 1458 |
| Potassium (mg/L) | 488 |
| Sodium (mg/L) | 12470 |
| Strontium (mg/L) | 7 |
| Bicarbonate (mg/L) | 141 |
| Boron (mg/L) | 2 2 |
| Carbonate (mg/L) | 8.0 |
| Chloride (mg/L) | 23073 |
| Fluoride (mg/L) | 1.5 |
| Sulfates (mg/L) | 2400 |

### Long-term Forward Osmosis Experiments

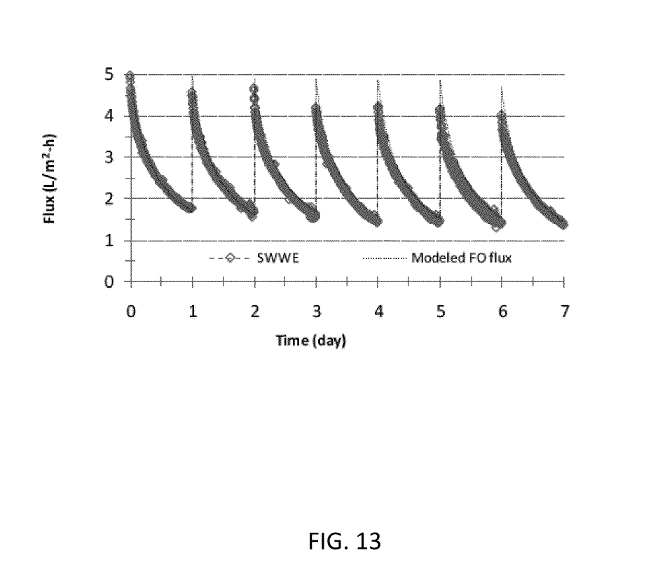

The forward osmosis flux decline for 7 cycles is given in FIG. 13. Only seven cycles out often cycles of osmotic filtration before cleaning are shown in FIG. 13; this is done intentionally, in order to demonstrate that Equation 6 is able to model the flux of the FO membranes in the FO cell. The peaks in FIG. 13, occurring at the beginning of each cycle are more difficult to model due to the mixing of remaining DS in the FO cell and the time of stabilization of the membrane to the fresh DS; this is more evident after the first 3 cycles. The flux fluctuated in the range 1.5-5 L/m²−h. Higher fluxes corresponding to fresh draw solutions fillings. The forward osmotic flux decreased due to continuous dilution of the feed water flowing into the osmotic membrane cell.

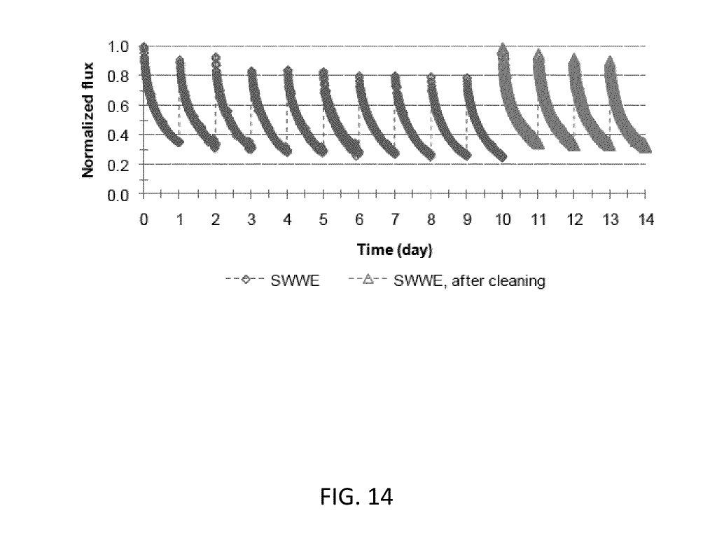

The complete number of cycles (10) before performing the cleaning of the membrane is given in FIG. 14, showing normalized fluxes. After 10 cycles, the flux decline was 28% due to fouling of the FO membrane. Then, the FO membranes were hydraulically cleaned with “air scouring with clean water” for half an hour. The reversible fouling (Rv) was 98.8% and the apparent irreversible fouling (Ira) was only 1.2%. The term apparent irreversible fouling is used in order to clarify that less or more flux may be recovered if concentrated feed water, feed water or clean water is implemented during the periodical air scouring. The following 4 cycles after cleaning the membrane show that the flux recovery of the FO membrane was quite acceptable. Replication experiments, with a different batch of feed water and with results not reported in this publication, were performed for a period of 12 days. After this period, the membrane fouling accumulated was also removed by air scouring, but this time using concentrated FW remaining in the tank, and for a period of 15 minutes. The flux recovered in this case was 90%; therefore, air scouring with clean water for a longer period of time was more effective than using concentrated FW and less time. These results demonstrate that the immersed FO membrane approach using feed tanks has advantages over FO counter-flow membrane contactors, where high cross-flow velocities are necessary to hydraulically control the fouling; alternatively, air scouring into spiral-wound membrane modules can alleviate fouling, and sometimes physical cleaning (scrubbing) is needed to partially restore the initial membrane flux.

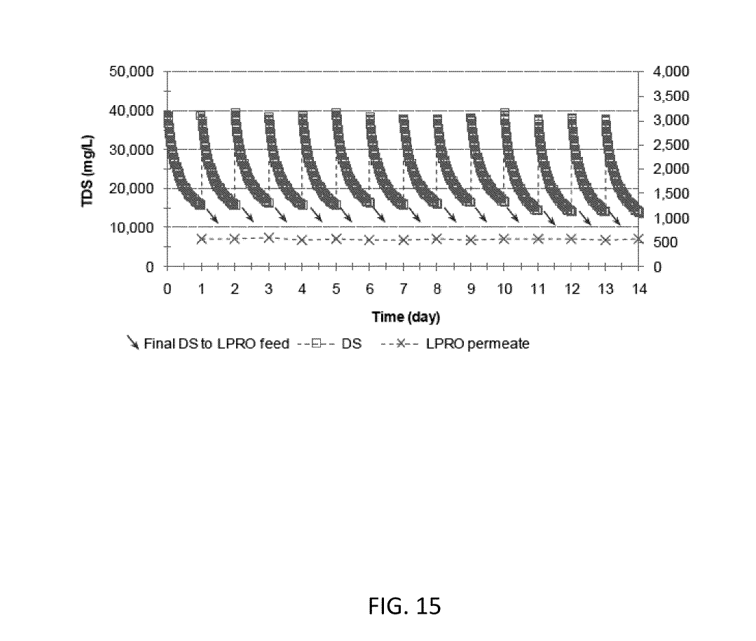

Desalination of the diluted DS was carried out with a LPRO unit. The operating flux of the LPRO unit was 7 L/m²−h at a pressure of 15 bar, with a recovery of 2%. By relating conductivity to total dissolved solids (TDS), the TDS is shown in FIG. 15; cycling resulted in favorable TDS content for feeding the LPRO system. Calculations with the final quality of the permeate demonstrated that more than 98% of dissolved salts were rejected.

The use of seawater is an appropriate draw solution for water reuse applications with FO membranes. Seawater is preferred over concentrate (retentate) from existing desalination plants because: i) Concentrates or brines contain high concentration of salts, and residuals of seawater pretreatment (pH regulators, anti-scalants, coagulants, sodium metabisulfite) can impact FO membrane performance; ii) shorter-term versus long-term cycles of osmotic operation in order to obtain a suitable dilution of the draw solution; iii) lower operating costs for desalination of the diluted solution (low-pressure) against high-energy desalination similar to high pressure RO.

Comparison of Energy Use

The energy consumption for desalinating water with RO membranes is between 3-4 kWh/m³ , this as a result of the development of new efficient membranes and the use of energy recovery devices over the last decade or so. The total energy consumption associated with the proposed technology (FO membrane cells immersed in tanks) of FO-LPRO revealed a conservative estimated range of 1.3-1.5 kWh/m³ for desalinating diluted seawater with water recovery from a SWWE. The calculation considered the energy consumption of the recirculation system, the stirring of the FW tank, periodical air scouring and the LPRO system. A comparison with existing SWWE water reclamation facilities makes FO-LPRO competitive; existing water reuse installations using membrane filtration (microfiltration or ultrafiltration) and RO have an overall energy demand of 1.5-1.7 kWh/m³. Therefore, indirect desalination with “immersed” FO membranes and LPRO is an attractive consideration at almost half of the energy demand of high pressure RO desalination. The following section presents alternatives of water reuse for direct use of diluted draw solutions; in this way, even lower energy use than the values previously mentioned can be achieved.

### Alternative Water Reuse of Diluted Draw Solutions

It was mentioned that low salinities can be reached by the FO system described in the present example (˜15 g/L as TDS). It is important to mention that this salinity can be even lowered to 6-10 g/L, when: 1) using a reduced volume of DS at the beginning of each FO cycle, 2) using a less concentrated DS (normal seawater has a TDS of 35 g/L), and 3) using more FO membrane area. Thus, the final TDS after the FO process can be controlled. This condition opens possibilities for direct use of a diluted draw solution. One option can be the use of the low salinity water as water for aquaculture. Low salinity (4-10 g/L) shrimp farming has been widely used in Thailand and there is interest in Saudi Arabia to move from seawater aquaculture to brackish water aquaculture (shrimps) employing partial desalination. The National Prawn Company in Saudi Arabia is looking into available alternatives to increase provision of clean brackish water, and one possibility could be the afore mentioned condition of diluted seawater with FO. Irrigation of crops with saline waters has been investigated in Saudi Arabia. Mixing saline waters with normal irrigation water is an option; therefore, a better hypothesized option may be the direct use or mixing of diluted seawater (less saline water) with normal irrigation water or with treated wastewaters. The tradeoffs between using a plain secondary wastewater effluent versus a mixed water can be further investigated, but definitely one advantage of the latter is the lower presence of toxic heavy metals and other micropollutants, therefore a minimized or no presence of toxic heavy metals in crops and soils is expected.

### Summary of Example 2

The high costs of desalinating water in coastal areas can impact decision making on implementation of desalination technology. The use of energy still remains as the main component of the costs of desalting water. Forward osmosis (FO) can help to reduce the costs of desalination, and extracting water from impaired sources can be beneficial in this regard. The recovery of FO was 7.3%, and low pressure reverse osmosis (LPRO) at a pressure of 15 bar and flux of 7 L/m²−h was implemented for indirect desalination with a coupled system of FO and LPRO. The system consumes only 50% of the energy used for normal high pressure RO desalination (3-4 kWh/m³), and produces a good quality water extracted from the impaired feed water. Fouling of the FO membranes was not a major issue during long-term experiments over 14 days. The observed flux decline was 28% after 10 days of continuous operation, but air scouring with clean water restored 98.8% of the initial flux.

### REFERENCES

All patents and publications mentioned in the specifications are indicative of the levels of those skilled in the art to which the invention pertains. All patents and publications are herein incorporated by reference to the same extent as if each individual publication was specifically and individually indicated to be incorporated by reference.
McGinnis, R.: US2005145568 (2005).
Cath, T. Y., Childress, A. E.: US20060144789 (2006)

### Example 1 References

1. Hoff, J. v. t., The Function of Osmotic Pressure in the Analogy between Solutions and Gases. Proceedings of the Physical Society of London 1887, 9, (1), 307.
2. Gibbs, W., Semi-Permeable Films and Osmotic Pressure. Nature 1897, 55, (1421), 461-462.
3. Pattle, R. E., Production of Electric Power by mixing Fresh and Salt Water in the Hydroelectric Pile. Nature 1954, 174, (4431), 660-660.
4. Scholander, P. F., How Mangroves Desalinate Seawater. Physiologia Plantarum 1968, 21, (1), 251-261.
5. Cath, T. Y.; Gormly, S.; Beaudry, E. G.; Flynn, M. T.; Adams, V. D.; Childress, A. E., Membrane contactor processes for wastewater reclamation in space: Part I. Direct osmotic concentration as pretreatment for reverse osmosis. Journal of Membrane Science 2005, 257, (1-2), 85-98.
6. Cath, T. Y.; Adams, D.; Childress, A. E., Membrane contactor processes for wastewater reclamation in space: II. Combined direct osmosis, osmotic distillation, and membrane distillation for treatment of metabolic wastewater. Journal of Membrane Science 2005, 257, (1-2), 111-119.
7. Lambert, M.; Lampi, K. In Forward osmosis, reality vs. perception, “an HTI perspective”, AMTA/Statkraft AS—2nd Osmosis Membrane Summit, San Diego, Calif., Jul. 11-12, 2010; San Diego, Calif., 2010.
8. The Barila Group; The Coca-Cola Company; The International Finance Corporation; McKinsey & Company; Nestle S. A.; New Holland Agriculture; SABMiller plc; Standard Chartered Bank; Syngenta AG Charting Our Water Future, Economic frameworks to inform decision-making; 2030 Water Resources Group: 2009.
9. Shannon, M. A.; Bohn, P. W.; Elimelech, M.; Georgiadis, J. G.; Marinas, B. J.; Mayes, A. M., Science and technology for water purification in the coming decades. Nature 2008, 452, (7185), 301-310.
10. Yangali-Quintanilla, V.; Maeng, S. K.; Fujioka, T.; Kennedy, M.; Amy, G., Proposing nanofiltration as acceptable barrier for organic contaminants in water reuse. Journal of Membrane Science 2010, 362, (1-2), 334-345.
11. Achilli, A.; Cath, T. Y.; Marchand, E. A.; Childress, A. E., The forward osmosis membrane bioreactor: A low fouling alternative to MBR processes. Desalination 2009, 239, (1-3), 10-21.
12. Cath, T. Y.; Hancock, N. T.; Lundin, C. D.; Hoppe-Jones, C.; Drewes, J. E., A multi-barrier osmotic dilution process for simultaneous desalination and purification of impaired water. Journal of Membrane Science 2010, 362, (1-2), 417-426.
13. Snyder, S. A.; Westerhoff, P.; Yoon, Y.; Sedlak, D. L., Pharmaceuticals, personal care products, and endocrine disruptors in water: Implications for the water industry. Environmental Engineering Science 2003, 20, (5), 449-469.
14. Ternes, T. A.; Joss, A.; Siegrist, H., Scrutinizing pharmaceuticals and personal care products in wastewater treatment. Environmental Science & Technology 2004, 38, (20), 392a-399a.
15. Cornelissen, E. R.; Harmsen, D.; de Korte, K. F.; Ruiken, C. J.; Qin, J.-J.; Oo, H.; Wessels, L. P., Membrane fouling and process performance of forward osmosis membranes on activated sludge. Journal of Membrane Science 2008, 319, (1-2), 158-168.
16. Gray, G. T.; McCutcheon, J. R.; Elimelech, M., Internal concentration polarization in forward osmosis: role of membrane orientation. Desalination 2006, 197, (1-3), 1-8.
17. Yangali-Quintanilla, V.; Sadmani, A.; McConville, M.; Kennedy, M.; Amy, G., A QSAR model for predicting rejection of emerging contaminants (pharmaceuticals, endocrine disruptors) by nanofiltration membranes. Water Research 2010, 44, (2), 373-384.
18. Loeb, S.; Titelman, L.; Korngold, E.; Freiman, J., Effect of porous support fabric on osmosis through a Loeb-Sourirajan type asymmetric membrane. Journal of Membrane Science 1997, 129, (2), 243-249.
19. Kiso, Y.; Kitao, T.; Jinno, K.; Miyagi, M., The Effects of Molecular Width on Permeation of Organic Solute through Cellulose-Acetate Reverse-Osmosis Membranes. Journal of Membrane Science 1992, 74, (1-2), 95-103.
20. Kiso, Y.; Kon, T.; Kitao, T.; Nishimura, K., Rejection properties of alkyl phthalates with nanofiltration membranes. Journal of Membrane Science 2001, 182, (1-2), 205-214.
21. Yangali-Quintanilla, V.; Verliefde, A.; Kim, T. U.; Sadmani, A.; Kennedy, M.; Amy, G., Artificial neural network models based on QSAR for predicting rejection of neutral organic compounds by polyamide nanofiltration and reverse osmosis membranes. Journal of Membrane Science 2009, 342, (1-2), 251-262.
22. Yangali-Quintanilla, V.; Sadmani, A.; McConville, M.; Kennedy, M.; Amy, G., Rejection of pharmaceutically active compounds and endocrine disrupting compounds by clean and fouled nanofiltration membranes. Water Research 2009, 43, (9), 2349-2362.
23. Cartinella, J. L.; Cath, T. Y.; Flynn, M. T.; Miller, G. C.; Hunter, K. W.; Childress, A. E., Removal of Natural Steroid Hormones from Wastewater Using Membrane Contactor Processes. Environmental Science & Technology 2006, 40, (23), 7381-7386.
24. Yip, N. Y.; Tiraferri, A.; Phillip, W. A.; Schiffman, J. D.; Elimelech, M., High Performance Thin-Film Composite Forward Osmosis Membrane. Environmental Science & Technology 2010, 44, (10), 3812-3818.
25. Zhang, S.; Wang, K. Y.; Chung, T.-S.; Chen, H.; Jean, Y. C.; Amy, G., Well-constructed cellulose acetate membranes for forward osmosis: Minimized internal concentration polarization with an ultra-thin selective layer. Journal of Membrane Science 2010, 360, (1-2), 522-535.
26. Liu, H.; Logan, B. E., Electricity Generation Using an Air-Cathode Single Chamber Microbial Fuel Cell in the Presence and Absence of a Proton Exchange Membrane. Environmental Science & Technology 2004, 38, (14), 4040-4046.
27. Rozendal, R. A.; Hamelers, H. V. M.; Rabaey, K.; Keller, J.; Buisman, C. J. N., Towards practical implementation of bioelectrochemical wastewater treatment. Trends in Biotechnology 2008, 26, (8), 450-459.

### Example 2 References

[1] C. Fritzmann, J. Löwenberg, T. Wintgens, T. Melin, State-of-the-art of reverse osmosis desalination, Desalination, 216 (2007) 1-76.
[2] Comprehensive Assessment of Water Management in Agriculture, Insights from the Comprehensive Assessment of Water Management in Agriculture, International Water Management Institute, 2006.
[3] Global Water Intelligence, Desal's double digit future, Global Water Intelligence, 2006.
[4] Global Water Intelligence, Desalination in 2008 Global Market Snapshot, Global Water Intelligence DesalData/IDA, 2008.
[5] GBI Research, Desalination Market to 2020—Technology driven cost reduction in membrane based processes set to drive sustainability investments into the market, GBI Research, 2010.
[6] N. Ghaffour, R. Venkat, The true cost of water desalination: review and evaluation, IDA World Congress Atlantis, The Palm, Dubai, UAE, 2009.
[7] Global Water Intelligence, Water Reuse Markets 2005-2015: A global assessment and forecast, Global Water Intelligence, 2005.
[8] T. Y. Cath, S. Gormly, E. G. Beaudry, 1 M. T. Flynn, V. D. Adams, A. E. Childress, Membrane contactor processes for wastewater reclamation in space: Part I. Direct osmoticconcentration as pretreatment for reverse osmosis, Journal of Membrane Science, 257 (2005) 85-98.
[9] J. R. McCutcheon, R. L. McGinnis, M. Elimelech, A novel ammonia—carbon dioxideforward (direct) osmosis desalination process, Desalination, 174 (2005) 1-11.
[10] R. W. Holloway, A. E. Childress, K. E. Dennett, T. Y. Cath, Forward osmosis forconcentration of anaerobic digester centrate, Water Research, 41 (2007) 4005-4014.
[11] A. Achilli, T. Y. Cath, E. A. Marchand, A. E. Childress, The forward osmosis membrane bioreactor: A low fouling alternative to MBR processes, Desalination, 239 (2009) 10-21.
[12] T. Y. Cath, N. T. Hancock, C. D. Lundin, C. Hoppe-Jones, J. E. Drewes, A multi-barrier osmotic dilution process for simultaneous desalination and purification of impaired water, Journal of Membrane Science, 362 (2010) 417-426.
[13] American Water Intelligence, The race to commercialize forward osmosis, American Water Intelligence, American Water Intelligence, 2011.
[14] C. Winter, Innovator: Robert McGinnis of Oasys Water, Bussinessweek, 2011.
[15] T. Y. Cath, D. Adams, A. E. Childress, Membrane contactor processes for wastewater reclamation in space: II. Combined direct osmosis, osmotic distillation, and membrane distillation for treatment of metabolic wastewater, Journal of Membrane Science, 257 (2005) 111-119.
[16] Y. -J. Choi, J. -S. Choi, H. -J. Oh, S. Lee, D. R. Yang, J. H. Kim, Toward a combined system of forward osmosis and reverse osmosis for seawater desalination, Desalination, 247 (2009) 239-246.
[17] J. -J. Qin, K. A. Kekre, M. H. Oo, G. Tao, C. L. Lay, C. H. Lew, E. R. Cornelissen, C. J. Ruiken, Preliminary study of osmotic membrane bioreactor: effects of draw solution on water flux and air scouring on fouling, Water Science & Technology, 62 (2010) 1353-1360.
[18] C. H. Tan, H. Y. Ng, Modeling of external and internal concentration polarization effect on flux behaviour of forward osmosis, Water Science & Technology, 8 (2010) 533-539.
[19] S. Loeb, L. Titelman, E. Korngold, J. Freiman, Effect of porous support fabric on osmosis through a Loeb-Sourirajan type asymmetric membrane, Journal of Membranl Science, 129 (1997) 243-249.
[20] G. T. Gray, J. R. McCutcheon, M. Elimelech, Internal concentration polarization in forward osmosis: role of membrane orientation, Desalination, 197 (2006) 1-8.
[21] T. Y. Cath, J. E. Drewes, C. D. Lundin, A Novel Hybrid Forward Osmosis Process for Drinking Water Augmentation using Impaired Water and Saline Water Sources, Colorado School of Mines Advanced Water Technology Center (AQWATEC), Environmental Science and Engineering Division, Golden, 2009.
[22] J. de Koning, D. Bixio, A. Karabelas, M. Salgot, A. Schafer, Characterisation and assessment of water treatment technologies for reuse, Desalination, 218 (2008) 92-104.
[23] E. Van Houtte, J. Verbauwhede, Operational experience with indirect potable reuse at the Flemish Coast, Desalination, 218 (2008) 198-207.
[24] B. W. Szuster, M. Flaherty, Inland low-salinity shrimp farming in the central plains region of Thailand, 2001.
[25] G. Hussain, A. J. Al-Saati, Wastewater quality and its reuse in agriculture in Saudi Arabia, Desalination, 123 (1999) 241-251.

What is claimed is:

1. A immersion forward osmosis cell apparatus comprising:
a first and second frame shaped plate;
an inner frame; and
a first and second forward osmosis membrane,
wherein the cell is assembled in the order of the first plate, the first membrane, the frame, the second membrane and the second plate, such that each membrane is located between a plate and the frame.

2. The apparatus of claim 1, further comprising two o-rings located between each membrane and the frame.

3. The apparatus of claim 1, further comprising two o-rings located between each membrane and each plate.

4. The apparatus of claim 1, wherein other than the membrane, the cell is configured to be water tight.

5. The apparatus of claim 1, additionally comprising an ingress tub and an egress tube wherein the ingress tube and egress tube are attached to the cell on opposite sides of each other.

6. The apparatus of claim 5, wherein there are more than one ingress tube or egress tube.

7. An apparatus comprising:
a draw solution tank;
a immersion forward osmosis cell;
a pump;
egress tubing; and
ingress tubing,
wherein the immersion forward osmosis cell is connected to the to the draw solution tank through the ingress tubing and through the egress tubing; and
wherein the pump is connected to either the ingress or the egress tubing.

8. The apparatus of claim 7, further comprising a feed water tank.

9. The apparatus of claim 8, wherein the immersion forward osmosis cell is located in the feed water tank.

10. The apparatus of claim 8, wherein the feed water tank further comprises an air scouring system.

11. The apparatus of claim 8, wherein the feed water tank further comprises a stirrer.

12. The apparatus of claim 8, wherein the feed water tank is connected to additional tubing that is configured to supply feed water.

13. The apparatus of claim 8, wherein the feed water tank further comprises a conductivity meter.

14. The apparatus of claim 8, further comprising a balance located under the feed water tank.

15. The apparatus of claim 7, wherein the ingress tubing or the egress tubing is connected to a pressure gauge.

16. The apparatus of claim 7, wherein the pump is a low pressure pump.

17. The apparatus of claim 7, wherein the pump is a gear pump.

18. The apparatus of claim 7, further comprising a balance located under the draw solution tank.

19. The apparatus of claim 7, wherein the draw solution tank further comprises a conductivity probe.

20. The apparatus of claim 7, wherein the draw solution tank is connected to additional tubing that is configured to supply draw solution to the draw solution tank.

21. The apparatus of claim 7, wherein the draw solution tank is connected to additional tubing that is configured to withdraw solution from the draw solution tank.

22. The apparatus of claim 7, further comprising a computer.

23. The apparatus of claim 22, wherein the computer is configured to monitor the apparatus.

24. The apparatus of claim 22, wherein the computer is configured to operate the apparatus.

25. The apparatus of claim 7, further comprising a low pressure reverse osmosis module.

26. The apparatus of claim 25, wherein the low pressure reverse osmosis system comprises a positive displacement pump and a reverse osmosis cross-flow filtration cell.

27. The apparatus of claim 25, wherein the low pressure reverse osmosis system comprises stainless steel tubing.

28. The apparatus of claim 25, wherein the low pressure reverse osmosis system comprises needle valves.

29. The apparatus of claim 25, wherein the low pressure reverse osmosis system comprises a proportional pressure relief valve.

30. The apparatus of claim 25, wherein the low pressure reverse osmosis system is connected to the draw solution tank.

31. The apparatus of claim 25, further comprising a pre-reverse osmosis tank.

32. The apparatus of claim 25, wherein the pre-reverse osmosis tank is connected to the draw solution tank through tubing.

33. The apparatus of claim 25, further comprising a post-reverse osmosis tank.

34. The apparatus of claim 25, wherein the low pressure reverse osmosis system comprises a pressure gauge.

35. A method for desalinating water, the method comprising:
providing an immersion forward osmosis cell connected to a source of draw solution;
immersing the forward osmosis cell in feed water;
pumping the draw solution through the forward osmosis cell and back into the draw solution source.

36. The method of claim 35, wherein the draw solution is salt water.

37. The method of claim 35, wherein the feed water is waste water.

38. The method of claim 35, wherein pumping comprises the use of a gear pump.

39. The method of claim 35, wherein the conductivity of the draw solution is monitored.

40. The method of claim 35, wherein the conductivity is monitored by a conductivity probe.

41. The method of claim 40, wherein the measurements of the conductivity probe are sent to a computer.

42. The method of claim 40, wherein when the computer detects that the conductivity measurements drop below a set level, the draw solution is replaced with new draw solution and/or the feed water is replaced with new feed water.

43. The method of claim 35, wherein the weight of the draw solution is monitored.

44. The method of claim 43, wherein the weight is monitored by a balance.

45. The method of claim 44, wherein the measurements of the balance are sent to a computer.

46. The method of claim 45, wherein when the computer detects that the weight measurement drop below a set level, the draw solution is replaced with new draw solution and/or the feed water is replaced with new feed water.

47. The method of claim 35, further comprising stirring the feed water.

48. The method of claim 35, further comprising air scouring the forward osmosis cell when soiled.

49. The method of claim 35, further comprising measuring the pressure of the pumped draw solution.

50. The method of claim 35, further comprising filtering the draw solution with low pressure reverse osmosis.

51. The method of claim 50, wherein the low pressure reverse osmosis comprises a positive displacement pump and a reverse osmosis cross-flow filtration cell.

52. The method of claim 36, wherein the salt water becomes desalinated at low pressures.
